(19) United States
(12) Patent Application Publication
(10) Pub. No.: US 2003/0154394 A1
(43) Pub. Date: Aug. 14, 2003

(54) Computer virus control

(76) Inventor: Lawrence R. Levin, Markham (CA)

Correspondence Address: John C. McMahon, PO Box 30069, Kansas City, MO, 64112, US

(21) Appl. No.: 10/074,842

(22) Filed: Feb. 13, 2002

(51) Int. Cl. G06F 11/30

(52) U.S. Cl. 713/200

(57) ABSTRACT

Virus control is provided for a plurality of clients of an e-mail server associated with a network by centrally monitoring for a pre-defined activity at any of the plurality of clients. On discovery of the pre-defined activity at a given one of the plurality of clients, e-mail traffic from the given client is blocked. The pre-defined activity may be monitoring for e-mail from clients which is addressed to any of a plurality of pre-defined addresses. These pre-defined addresses may be salted through the address book of a client such that they are likely to be utilised by a computer virus which tries to send e-mail.

### BACKGROUND OF THE INVENTION

This invention relates to an approach to control computer viruses.

A computer virus can impair the function of a computer, or a computer network, resulting in lost productivity. Many products exist to combat computer viruses. These products are typically software on a computer which scan files looking for signatures (i.e., patterns of program code) of known viruses. If a virus is detected, the anti-virus software will warn the user and may take certain remedial action. Since new viruses regularly arise, regular updating of the anti-virus software is necessary so that these new viruses may be detected. However, many users are not vigilant in updating their anti-virus software, leaving their computers vulnerable to new viruses. Furthermore, some viruses spread rapidly such that even the computer of a vigilant user may be vulnerable between updates. Yet further, some sophisticated viruses are polymorphic, meaning that they are capable of changing their signature. This further complicates successful detection with these anti-virus software products.

This invention seeks to provide a different approach to controlling computer viruses.

### SUMMARY OF INVENTION

Virus control is provided for a plurality of clients of an e-mail server associated with a public and/or private network by centrally monitoring for a pre-defined activity at any of the plurality of clients. On discovery of the pre-defined activity at a given one of the plurality of clients, e-mail traffic from the given client is blocked.

According to the present invention, there is provided a method of virus control for a plurality of clients of an e-mail server, said e-mail server associated with a network, said method comprising: centrally monitoring for a pre-defined activity at any of said plurality of clients; on discovery of said pre-defined activity at a given one of said plurality of clients, blocking e-mail traffic from said given client, said pre-defined activity comprising receiving an e-mail message from said given client having a pre-defined recipient address.

According to another aspect of the present invention, there is provided a method of virus control at a server side for a plurality of clients, said server side handling e-mail traffic to and from a network, comprising: receiving an e-mail message at said server side from a given client of said plurality of clients; checking a recipient address of said e-mail message for a pre-defined recipient address; on discovery of said pre-defined recipient address, blocking e-mail traffic from said given client.

According to a further aspect of the invention, there is provided a method for facilitating virus control, comprising: salting stored data accessible by each of a plurality of clients of an e-mail server, which data normally contains e-mail addresses, with a plurality of fictitious e-mail addresses, each of said addresses having a valid format.

According to another aspect of the invention, there is provided a processor adapted for virus control, comprising: means for monitoring for e-mail from any of a plurality of clients addressed to any of a plurality of pre-defined addresses; means for, on discovery of e-mail from a given client addressed to one of said pre-defined addresses, blocking e-mail traffic from said given client.

According to a further aspect of the invention, there is provided a computer readable medium, which when loaded into a processor, adapts said processor to: monitor for e-mail from any of a plurality of clients addressed to any of a plurality of pre-defined addresses; on discovery of e-mail from a given client addressed to one of said pre-defined addresses, block e-mail traffic from said given client.

Other features and advantages of the invention will become apparent by reviewing the following description in conjunction with the drawings.

### BRIEF DESCRIPTION OF THE DRAWINGS

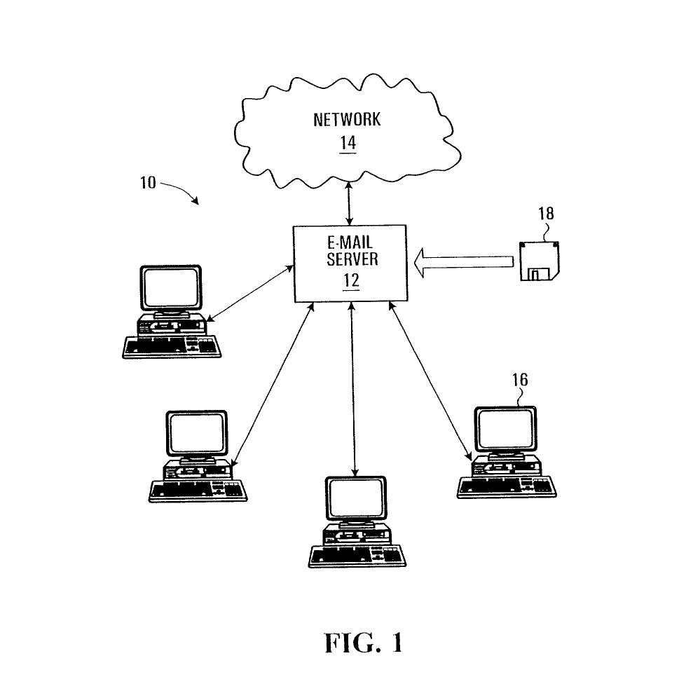

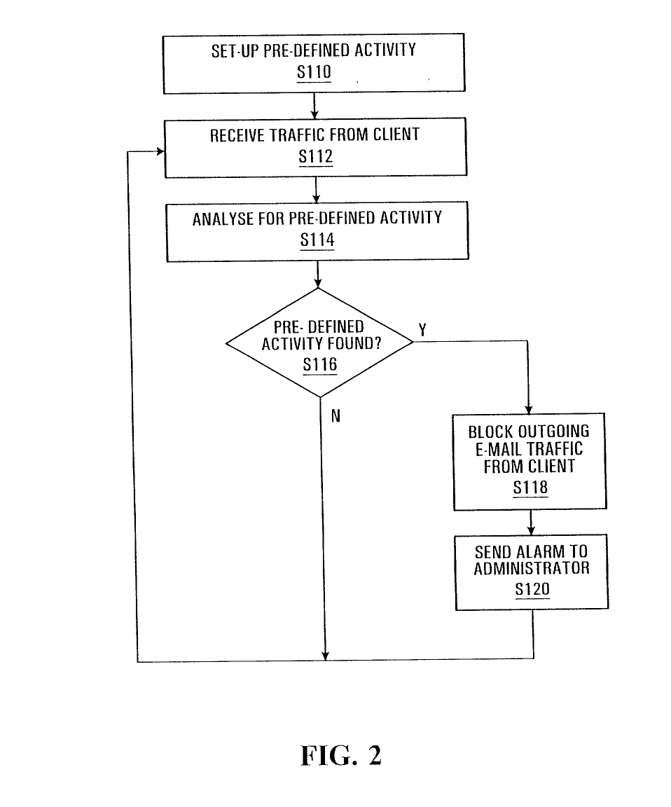

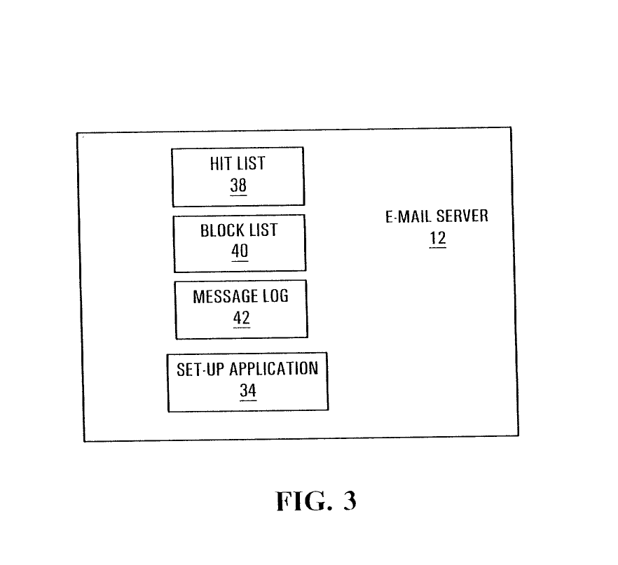

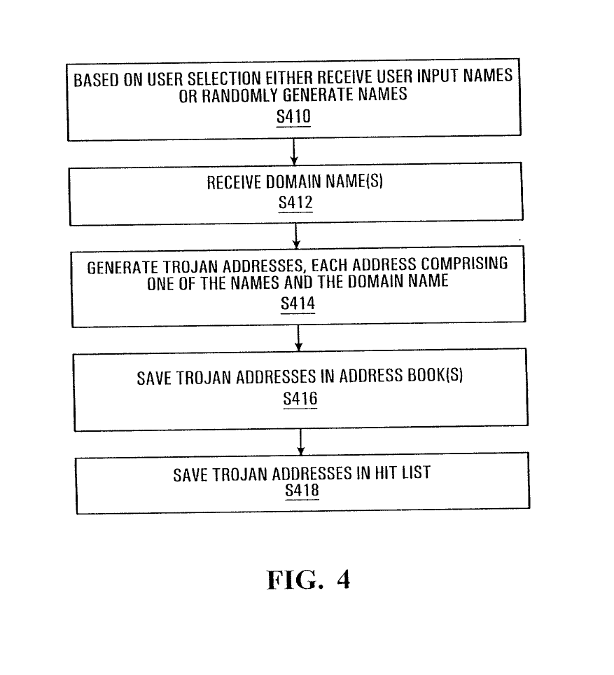

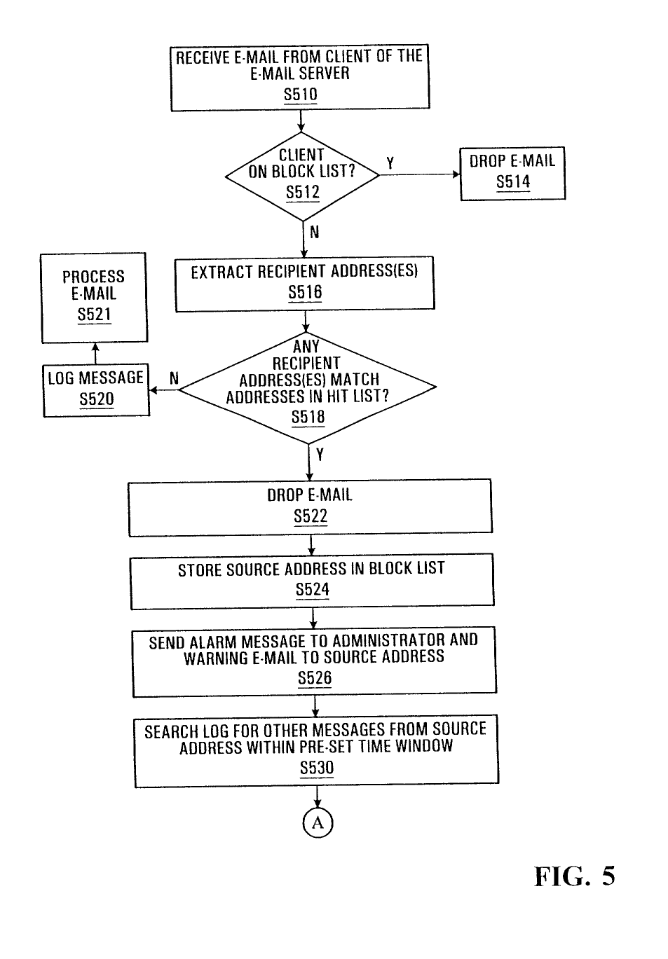

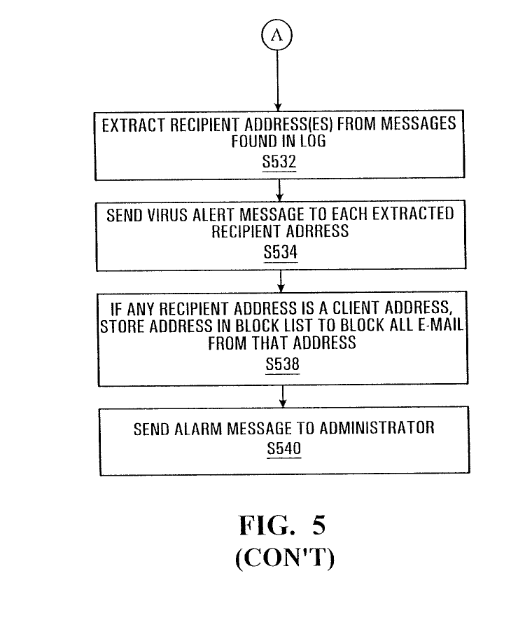

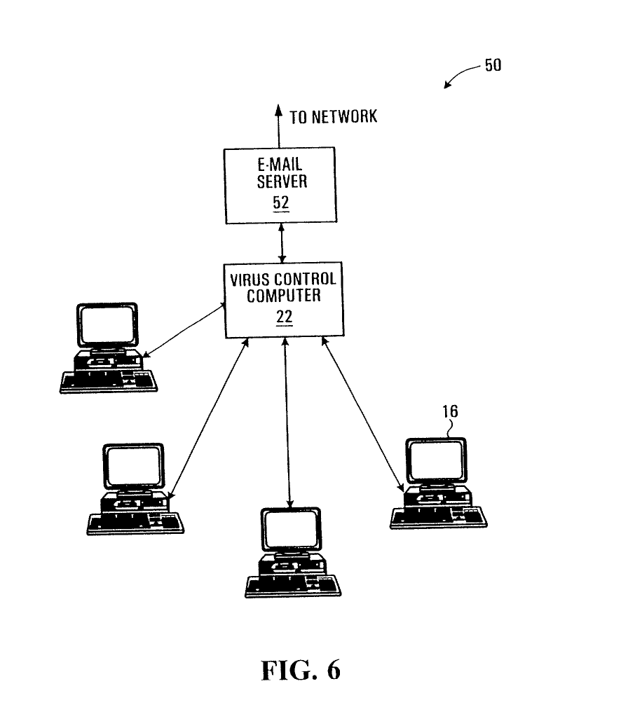

In the figures which illustrate example embodiments of the invention, FIG. 1 is a schematic view of a system which may employ the subject invention, FIG. 2 is a flow diagram illustrating operation of an embodiment of the subject invention, FIG. 4 illustrates operations to prepare a server for use of an embodiment of the subject invention, FIG. 3 illustrates a server provisioned in accordance with an aspect of this invention, FIG. 5 is a flow diagram illustrating operation of an embodiment of the subject invention, and FIG. 6 is a schematic view of another system which system is specially adapted to employ an embodiment of this invention.

### DETAILED DESCRIPTION

Turning to FIG. 1, a system 10 which may employ the subject invention comprises an e-mail server 12 with a plurality of clients 16. The e-mail server is associated with a data network 14 which may be the public Internet. The clients may be personal computers or other network connectable devices with a user interface (such as palm tops). The e-mail server may be a suitably programmed processor. The e-mail server and clients may comprise a local area network (LAN). With a LAN, the e-mail server acts as a node for LAN e-mail traffic as well as providing e-mail access to network 14. Alternatively, the clients 16 may intermittently connect to the e-mail server via a public switched telephone network (PSTN) or cable system in order to gain access to network 14. As a further alternative, the clients may connect to the e-mail server over a public network. In a typical system, traffic from a client will identify the client as being a client of the server. For example, with internet protocol (IP) traffic, the IP address assigned to a client has a network portion which is common to clients of the server.

To enable operation in accordance with this invention, the e-mail server 12 is reconfigured with software from a computer readable medium 18. Computer readable medium 18 may be, for example, a disk, a read-only memory, or a file downloaded from a remote source.

With reference to FIG. 2, in operational overview, the e-mail server 12 in system 10 is set up to monitor a pre-defined activity (S110). The e-mail server then receives e-mail traffic from clients (S112) and analyses the traffic for the pre-defined activity (S114). If the pre-defined activity is found in association with outgoing e-mail traffic from a given client (S116), all outgoing e-mail traffic from that client is blocked until such time as an operator resets the e-mail server (S118). Additionally, an alarm may be sent to a system administrator (S120).

The pre-defined activity is one which is symptomatic of the behaviour of a computer virus. Thus, the e-mail server is, in effect, monitoring e-mail traffic from each client for signs of virus infection. When e-mail traffic from a client provides a sign of infection, the client is “quarantined” (i.e., isolated) by blocking all e-mail traffic from the client. In this way, spread of a virus may be curtailed.

A common activity of a computer virus is looking up e-mail addresses in the address book of an e-mail application of a client, and/or in other places that these addresses are normally stored at the client, and sending e-mail to these addresses attaching a copy of the virus. Recognising this, the pre-defined activity monitored for could be, for example, a burst of e-mail messages sent from a client in a short (pre-defined) time window, which burst comprises a number of messages that exceeds a (pre-defined) threshold.

Another pre-defined activity which may be monitored for is the sending of “trojan” e-mail. Trojan e-mail is e-mail having a recipient address which has a valid format but a fictitious recipient. Where the valid format of the e-mail address is name@domainname, the name will be fictitious, but the domain name may be valid.

With reference to FIG. 3, to configure system 10 for “trojan” e-mail monitoring, the e-mail server 12, is configured with software from medium 18. This provisions the e-mail server 12 with a data structure for a hit list 38, a data structure for a block list 40 and a data structure for a message log 42 and with a set-up application 34.

The set-up application may create trojan addresses as follows. With reference to FIG. 3, the set-up application allows a system administrator to input names or choose to have the application pseudo-randomly generate names (S310). The administrator may be guided in his input of names. The purpose of the guidance, or of the pseudo-random generation, is so that the first letter of the last names reflects a pre-defined distribution. This distribution could be simply to ensure that the majority of the letters of the alphabet are represented. Or the distribution could more or less reflect a distribution which is typical for names in the particular geographical region of system 10 (e.g., in North America). The set-up application then receives one or more domain names that may have been part of the software load (S312) and generates “trojan” e-mail addresses (S314), each address comprising one of the names and one of the domain names. Thus, each trojan address is directed to a fictitious recipient, but has a valid format and may have a valid domain name.

Where system 10 is a LAN, the set-up application may simply save the trojan addresses in a global address book for the LAN. Alternatively, or additionally, trojan e-mail addresses may be provided to each client for storage in one or more of the address books of the e-mail application of each client. This has the effect of salting the address book(s) with trojan addresses (S316). The trojan addresses may be sent to the client by the server and the client loaded with appropriate software to effect the storage of these addresses in the appropriate address book(s), or the trojan addresses may simply be manually added to the address book(s) of each client. The set-up application also stores each trojan address in hit list 38.

After this set-up, e-mail server 12 is readied to monitor for e-mail symptomatic of an infection by a virus at one of the client computers. More particularly, with reference to FIG. 5, when the e-mail server 12 receives e-mail, it extracts the source address from the e-mail and determines from this whether the e-mail is from a client. On receipt of an e-mail from a client (S510), the e-mail server will check whether or not the client's source address is stored in the block list (S512). If it is, the e-mail server simply drops the e-mail (S514).

Assuming that the client's source address is not in the block list, the e-mail server extracts the recipient address(es) from the e-mail (S516). The hit list 38 is then searched for any of these recipient addresses (S518). If none are found, the e-mail message is logged in the message log (S520) and the e-mail server processes the e-mail in normal fashion (S521). The logging of a message could simply involve storing the source and recipient addresses from the message along with the time it was sent. The e-mail server then waits to process the next e-mail message.

If, on the other hand, any of the recipient addresses are on the hit list 38, the e-mail is dropped (S522). Additionally, the source address for the identified client is stored in the block list (S524) and an alarm is sent to the system administrator (S526). By storing the source address for the client in the block list, the client is quarantined (i.e., isolated): any future e-mail sent by it will simply be dropped.

Additionally, on finding that a recipient address is in the hit list, a warning message may be sent back to the quarantined client by e-mail (S526). Furthermore, the message log 42 is searched for other messages sent by the quarantined client within a preset time window extending backwards in time from the present (S530). Where other messages from the quarantined client are found, the recipient addresses from these messages are extracted (S532) and the server sends a message to each of these recipient addresses. These messages identify the quarantined client and warn that any recently received message from that client may contain a virus (S534). If the found recipient addresses are client addresses, the quarantined computer has recently sent a message to another client of the e-mail server. In such case, the e-mail address of that other client is also stored in the block list (S538) and another alarm is sent to the administrator (S540). Alternatively, in place of S532 to S540, where other messages from the quarantined client are found, these messages may simply be sent to the system administrator for appropriate action.

Once an address is stored in the block list, it can only be removed by a system administrator. In this way, a client may be quarantined until the client has been checked for viruses and any viruses discovered, removed.

Traffic to and from e-mail server 12 typically follows the Internet Protocol (IP). IP e-mail traffic is transferred from node to node in the network using the simple mail transfer protocol (SMTP). An IP address ends in a port number that indicates the nature of the traffic. By convention, port 25 is used to designate simple mail transfer protocol (SMTP) traffic. Thus, in an IP network, e-mail server 12 will be an SMTP e-mail server.

With an IP network, a client may be given an IP address for each network session (e.g., each time it is turned on, or each time it connects to a network). Although the IP address could be different for each session, as aforenoted, it has a network portion which is invariant. This IP address will be part of each e-mail communication from the client. Optionally, the e-mail sever 12 may store the IP address of a client in the block list as well as the client's source e-mail address and also block future e-mail from the IP address.

In an alternate system 50 illustrated in FIG. 6 which is specially adapted for use with the subject invention, the clients 16 communicate directly with a virus control computer 22. The virus control computer 22 communicates with the e-mail server 52. With the system of FIG. 6, all e-mail traffic from clients 16 passes through virus control computer 22 to reach e-mail server 52. The virus control computer is configured to monitor for viruses. More particularly, the virus control computer 22 runs a virus control application which operates as described in conjunction with FIGS. 4 and 5. The only exception is that at S521, the virus control computer sends the e-mail to the e-mail server 52. This can be implemented simply in an IP network by making two changes to the name table of the internal name server used by clients 16. Firstly, the mapping of the original name for the SMTP e-mail server 52 to the IP address of the SMTP server 52 is changed to a mapping to the IP address for the virus control computer 22. In consequence, when a client sends e-mail directed to the SMTP server, the e-mail ends up at the virus control computer. Secondly, a new mapping is added from a new name for the SMTP server to the IP address of the SMTP server. The virus control computer 22 uses this new SMTP server name to direct e-mail to the SMTP server (at S521). Thus, all clients using this specific SMTP server will seamlessly be routing their e-mail through the virus control computer. As will be appreciated by those skilled in the art, all e-mail traffic incoming from the network 14 could simply be sent directly to the SMTP server.

Whatever the configuration of the system, the virus control application runs on the server side of the system and looks for pre-defined activity at the client side of the system.

At S530, rather than searching for other messages from the source address within a pre-set time window, the search may be a reverse time order search for a pre-set number of messages from the source address. With this operation, to avoid unnecessary quarantining, S536 to S540 may be omitted.

Some viruses look for e-mail addresses in places other than the address book(s) of an e-mail application of the client. For example, a virus may look for addresses in the In-box or Out-box of the e-mail application, or in cached web pages. Recognising this, instead of, or in addition to salting the address book(s) of the e-mail application of each client computer with trojan addresses, other data stores at the client where e-mail addresses are normally stored may be salted with trojan addresses. A trojan address may be added to the in-box by adding a message including the trojan address as the source address. Similarly, a trojan address may be added to the out-box by including a message with the trojan address as the destination address.

Some viruses may attempt to send e-mail to a remote e-mail server. A firewall can be used to try to block any such attempt. Alternatively, or additionally, in the embodiment of FIG. 1, some or all of the trojan addresses may have a domain name representative of e-mail server 12. Thus, should a virus succeed in directing e-mail to a remote e-mail server, mail with a trojan recipient address having a domain name representative of e-mail server 12 will be delivered to e-mail server 12. E-mail server 12 may be configured to operate on e-mail incoming from network 14 in the same way it operates on e-mail from its clients, quarantining any client which is found to have sent e-mail with a trojan address. To further guard against such a virus, the domain name of some of the trojan addresses may point to a remote server which has been configured such that if it receives any e-mail from these trojan addresses, it alerts e-mail server 12. With this arrangement, e-mail server 12 and the remote server work together to provide the operation outlined in FIG. 2.

Other modifications will be apparent to those skilled in the art and, therefore, the invention is defined in the claims.

What is claimed is:

1. A method of virus control for a plurality of clients of an e-mail server, said e-mail server associated with a network, said method comprising:
centrally monitoring for a pre-defined activity at any of said plurality of clients;
on discovery of said pre-defined activity at a given one of said plurality of clients, blocking e-mail traffic from said given client,
said pre-defined activity comprising receiving an e-mail message from said given client having a pre-defined recipient address.

2. The method of claim 1 wherein said pre-defined recipient address addresses a fictitious recipient.

3. The method of claim 1 further comprising:
logging e-mail messages sent by said plurality of clients in a message log;
on discovery of said pre-defined recipient address in said e-mail message from said given client, searching said message log for other e-mail messages sent by said given client.

4. The method of claim 3 further comprising:
on finding one or more of said other e-mail messages, identifying recipient addresses in said one or more other e-mail messages and sending a virus alert e-mail message to each identified recipient address.

5. The method of claim 1 wherein said blocking e-mail traffic from said given client comprises dropping e-mail from said given client.

6. The method of claim 1 wherein said centrally monitoring comprises monitoring at an e-mail server.

7. The method of claim 1 further comprising, on discovery of said pre-defined recipient address in said e-mail message from said given client, sending a virus alert message to said given client.

8. A method of virus control at a server side for a plurality of clients, said server side handling e-mail traffic to and from a network, comprising:
receiving an e-mail message at said server side from a given client of said plurality of clients;
checking a recipient address of said e-mail message for a pre-defined recipient address;
on discovery of said pre-defined recipient address, blocking e-mail traffic from said given client.

9. The method of claim 8 further comprising:
logging e-mail messages sent by said plurality of clients in a message log;
on said discovery of said pre-defined recipient address in said e-mail message from said given client, searching said message log for other e-mail messages sent by said given client.

10. The method of claim 9 wherein said searching comprises searching for messages sent by said given client within a pre-determined time of a time of sending of said e-mail message.

11. The method of claim 9 further comprising:
on finding one or more of said other e-mail messages, identifying recipient addresses in said one or more other e-mail messages and sending a virus alert e-mail message to each identified recipient address.

12. The method of claim 9 further comprising:
on finding one or more of said other e-mail messages, identifying each recipient address and, where an identified recipient address is for one of said plurality of clients, blocking all e-mail traffic from said one of said plurality of clients.

13. The method of claim 11 wherein said searching comprises searching for messages sent by said given client within a pre-determined time of a time of sending said e-mail message.

14. The method of claim 11 wherein said searching comprises searching in reverse time order from a time of sending of said e-mail message for a pre-determined number of messages sent by said given client.

15. The method of claim 8 wherein said checking comprises checking said recipient address of said e-mail message against a list of recipient addresses.

16. The method of claim 8 wherein said blocking e-mail traffic from said given client comprises dropping e-mail traffic received from said given client.

17. The method of claim 9 wherein said logging e-mail messages comprises logging sending and receiving addresses from said e-mail messages along with times of sending.

18. The method of claim 8 further comprising:
on discovery of said pre-defined recipient address, sending an alarm notification.

19. The method of claim 15 wherein said list of recipient addresses comprises addresses beginning with at least a majority of letters of the alphabet.

20. A method for facilitating virus control, comprising:
salting stored data accessible by each of a plurality of clients of an e-mail server, which data normally contains e-mail addresses, with a plurality of fictitious e-mail addresses, each of said addresses having a valid format.

21. The method of claim 20 wherein said stored data comprises at least one of an address book of an e-mail application, a message store of an e-mail application, and a web page.

22. The method of claim 20 further comprising choosing said fictitious e-mail addresses such that for each letter of a majority of letters of the alphabet there is a fictitious e-mail address beginning with said letter.

23. The method of claim 20 further comprising:
storing said plurality of fictitious e-mail addresses for each of said plurality of clients at said e-mail server.

24. The method of claim 20 further comprising:
on receiving, at said e-mail server, an e-mail message from a given client addressed to one of said plurality of fictitious addresses, blocking all e-mail traffic from said given client.

25. The method of claim 24 wherein said e-mail server is a simple mail transfer protocol server.

26. The method of claim 24 wherein said blocking all e-mail traffic from said given client comprises at least one of blocking e-mail traffic having a source address pointing to said given client and blocking e-mail traffic having a network address most recently associated with said given client.

27. A processor adapted for virus control, comprising:
means for monitoring for e-mail from any of a plurality of clients addressed to any of a plurality of pre-defined addresses;
means for, on discovery of e-mail from a given client addressed to one of said pre-defined addresses, blocking e-mail traffic from said given client.

28. The processor of claim 27 further comprising a hit list for storing said plurality of pre-defined addresses.

29. A computer readable medium, which when loaded into a processor, adapts said processor to:
monitor for e-mail from any of a plurality of clients addressed to any of a plurality of pre-defined addresses;
on discovery of e-mail from a given client addressed to one of said pre-defined addresses, block e-mail traffic from said given client.
